(19) United States
(12) Patent Application Publication
(10) Pub. No.: US 2014/0133481 A1
(43) Pub. Date: May 15, 2014

(54) Web Telephone with Integrated Voice and Data

(71) Applicant: PINGSHOW INC., San Jose, CA (US)

(72) Inventor: Shi-Chang Wang, San Jose, CA (US)

(73) Assignee: PINGSHOW INC., San Jose, CA (US)

(21) Appl. No.: 13/796,081

(22) Filed: Mar. 12, 2013

Related U.S. Application Data
(60) Provisional application No. 61/724,999, filed on Nov. 11, 2012.
(60) Provisional application No. 61/725,008, filed on Nov. 11, 2012.

(51) Int. Cl. H04M 1/247

(52) U.S. Cl. CPC H04M 1/2473
USPC 370/352

(57) ABSTRACT

Techniques are provided for more efficient communication between two or more entities via a web telephone with integrated voice and data. A phone call may be made from a web page by a calling party and the calling party's related information may be transmitted to a called party concurrently. In addition, a conference call between several participants can be made by sending a message to each participant directing to a web page for joining a conference call and exchanging texts. Further, a secured web page can display various information of and sent by calling parties during the voice communication.

### CROSS-REFERENCE

This application claims the benefit of U.S. Provisional Application with Ser. No. 61/724,999, filed on Nov. 11, 2012, and of U.S. Provisional Application with Ser. No. 61/725,008, filed on Nov. 11, 2012, the entire contents of both of which are hereby incorporated by reference as if fully set forth herein, under 35 U.S.C. §119(e).

### FIELD OF INVENTION

The present invention relates to systems for making phone calls, and more specifically, to techniques for initiating phone calls and transferring related data concurrently.

### BACKGROUND

Typical customer service call, such as 1-800 toll free number, has many drawbacks including long wait time through menu selections, higher cost due to the extra wait time, possible mistakes during exchange of information and customer's reluctance of disclosing private information (e.g. personal phone numbers), etc. If there is a lot of information to be exchanged over the phone, miscommunication is very likely to happen. For example, names and addresses need to be spelled and verified by both parties, customer's preferences and product information need to be communicated although they are available right on the website, and even worse a customer may dial the wrong number.

Although Voice over Internet Protocol (VoIP) is a viable option in addition to the traditional phone because of lower cost, a few reasons have kept this voice communication through internet from a widespread use. Security is one of the top reasons. Today's VoIP is not secure and can be easily hacked because the enterprises do not have the control over the encryption key. Cost of ownership is high if an enterprise wants to deploy the systems itself, not to mention the cost of maintenance and services. Quality of service is not reliable due to communication on IP network that could drop packets as compared to circuit switched public telephone network. There is also no communication suite or Application Programming Interface (API) available for VoIP for private cloud server deployment.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

In contrast to the traditional customer service call, a web integrated voice and data in one service call is disclosed. This can eliminate the time for placing a call or a possibility of dialing a wrong number, lengthy menu option selections to reach a desired party (e.g. a particular sales department) and avoid the exchange of information which may cause unwanted mistakes, by passing the stored information to be exchanged directly to customer service center at the time of placing the call. In addition, sending encrypted exchanged information to receiver reduces amount of voice information to be communicated over the phone which is less secure.

Another aspect of this voice and data integration through web call is that no personal phone number information will be disclosed to the receiving end due to the VoIP technology and all data transmitted or exchanged are encrypted. This feature allows customers to place calls from anywhere through any devices with web browsers with integrated text Instant Message (IM) live support system.

In one embodiment, an apparatus for web telephone communication includes a web page and an icon displayed on said web page. The icon is configured to enable a calling entity to initiate a phone call. An element of the web page for storing information including at least one phone number, account identification and web address of the web page is associated with the displayed icon and encoded in Uniform Resource Locator (URL) format. The element of the web page is decoded to obtain the at least one phone number to initiate the phone call when the calling entity clicks on the displayed icon.

In another embodiment, a web browser may receive a request to initiate a phone call to a called entity. An element of a web page on the web browser is retrieved in response to the received request, and decoded to obtain an identification information associated with a calling entity and at least one phone number for initiating the phone call. Once a voice communication and a data communication with the called entity identified by the at least one phone number are established, data associated with the identification information is transmitted to the called entity.

These and other embodiments will become apparent upon reference to the following description and accompanying drawings.

### BRIEF DESCRIPTION OF DRAWINGS

The present invention is illustrated by way of example, and not by way of limitation in the figures of the accompanying drawings and in which like reference numerals refer to similar elements and in which:

FIG. 1 is a block diagram illustrating an exemplary architecture upon which embodiments of the invention may be implemented;

FIG. 2A illustrates an information storage format for mobile/tablet/PAD device, according to an embodiment;

FIG. 2B illustrates an information storage format for PC/Mac device, according to an embodiment;

FIG. 3 is a block diagram illustrating information displayed on a portal web page, according to an embodiment;

FIG. 4 is a flowchart illustrating steps for performing an end to end operation, according to an embodiment;

FIG. 5 is a block diagram illustrating a communication protocol of PC architecture, according to an embodiment;

FIG. 6 is a block diagram illustrating a communication protocol of mobile/tablet/PAD architecture, according to an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

In this disclosure, the term, user, customer, calling entity or source entity may be referred to one who initiates a call and/or sends data. Likewise, the terms, receiver, customer service center, called entity or destination entity may be referred to one who receives the call and/or data. Additionally, the terms, sender and receiver may be used to describe communication without designating either party as seller or purchaser. Further, a company may be a user who uses the service while another company or an individual may be a receiver that provides services to users to access the functions described in the following embodiments of the present invention.

Internet has changed the way people communicate and shop. In fact, the benefit of web interaction has been proven to be useful to product sales. According to Dataquest report, web interaction between customers and corporate sales centers can increase sales by at least 156% as compared to that without web interaction.

As what will be described in detail later, the voice and data integration feature is deployed through cloud technology. In order to support web integrated voice and data service, there are various types of servers involved to enable this service, which include but not limited to, Push Notification Management Server, LBS tracking server, Security and Provisioning Management Server, Files Management Server, MMS/SMS/VoIP/Video over IP Servers, SIP Trunking Relay Server, TCP/UDP Connection Server, Peer to Peer and TURN Server, and Distributed and Cloud based Client Management Server. Each of these servers plays a specific role and works together as a whole to allow this web integrated voice and data technology possible.

There are various Application Programming Interfaces (APIs) to enable this service on client's devices. The list of APIs includes, but not limited to, (1) MMS, SMS, Walki-Talkie, VoIP, VideoIP, Email; (2) File Sharing, Viewer, Picture and Video cloud storage and transfer; (3) LBS location, sharing and tracking; (4) Web management, Instant Messaging and Webcall; (5) AEC, High-Definition audio and Transcoding engine; (6)Audio Codec such as G711, G722, Speex, AMR-NB and AMR-WB; (7) Video Codec such as H264, MP4 and VP8. The platforms supported include iPhone, Andriod, iPad, Android Pad, Personal Computer (PC), etc.

### Introduction to Web Integrated Voice and Data Infrastructure

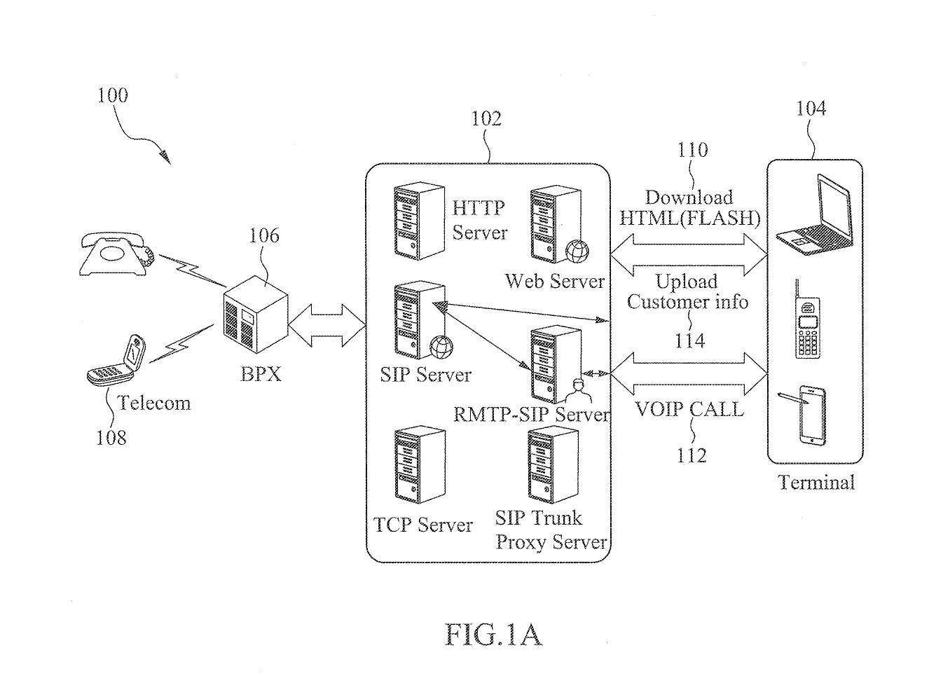

FIG. 1 is a block diagram illustrating an exemplary architecture upon which embodiments of the invention may be implemented. The infrastructure 100 for web integrated voice and data is shown. There are various kinds of servers 102, including SIP server, Real Time Messaging Protocol (RTMP)-SIP server and SIP trunk proxy server, (herein collectively referred to as “SIP related servers”), TCP servers and HTTP servers in the cloud infrastructure. Note that not all servers have been shown in this figure.

A service provider can prepare a Flash or plug-in software 110 to create a call button on a web site displayed by end point devices 104 including, but not limited to, Personal Computer (PC),mobile devices or tablets/pad devices. When a call is made, VoIP call 112 is established to SIP server for mobile client and to RTMP-SIP server for PC client, and then through phone company's BPX systems 106 or SIP trunk proxy server (for connecting to traditional PSTN phone) to reach the receiver's devices 108 which can also be traditional telephones, PC or mobile devices. At the same time, user or customer's data 114 is uploaded to dedicated servers (Web servers, HTTP servers and TCP servers) and transferred to servers on receiver side so the receiver can log into a customer service portal web page to view those information.

### Voice and Data Integration Through Web Browsers

The underline mechanism of web integrated voice and data technology starts from a phone call button which is embedded into any website on any devices by using javascripts and HyperText Markup Language (HTML) codes. When users click the call button, it allows the software to dial any number in the world and no personal phone numbers is disclosed or used because of dynamically assigned IP address on internet. And even with fixed-IP address, the location accuracy is limited to city level using WiFi geolocation scheme.

The voice part of this web integrated technology is activated when a user clicks the call button on a web browser which can provide routes to two types of end devices, a traditional Plain Old Telephone Service (POTS) device (aka. Public Switch Telephone Network, PSTN) and a Session Initiation Protocol (SIP) enabled device. Software plug-ins behind web browser are used to enable this function on both PC/Mac and mobile devices. The voice data can be encrypted to provide security.

The data part of this web integration technology is uploaded by software plug-in to computer servers at the same time when the call is made and the receiving party can immediately knows the user's information as soon as the call is connected. The user's information can include one or more of the followings, but not limited to—information about user's web page location, browser cookies which store user's data, user's web interaction information and information entered by the user on the website such as texts or files (e.g. image files or videos). All data are encrypted by various kinds of standards including Secure Sockets Layer (SSL) and other RFC standards.

The user's web page location provides the information that user is interested in or is viewing when making the call. It could be the URL of the web page currently displayed on user's web browser (e.g. a particular product page) or other type of information. For example, when a user is looking at a catalogue of cameras on a web page, the corresponding URL may be http://company_name/camera_catelogue. When a receiver obtains this information, the receiver immediately knows the intent of the caller. In contrast to traditional service call, the same customer service phone number is used for all customers who have interests in many different products and sales representatives have no idea what customers will be asking or their interests until a lot of information have been exchanged.

The browser cookies are small pieces of data stored in a user's web browser that contains states of websites or activities that the user has taken in the past. This allows the companies which host the websites to provide convenient services based on the cookies' information without the need of users to provide past history again, such as product information displayed on websites a user has visited and other collected user's preferences.

Information entered by a user on a website can be designed by the receiving entity (e.g. a service company) to request relevant information it likes to know before a customer makes a call. It may be specific products, customer address, or any relevant information required for purchasing a product.

### Web Call Buttons & Lines of Calls

Normally, a call button can be created on Flash Player enabled devices, such as PC or Mac, represented in a file format for multimedia use such as .swf file. This call button is connected to some secure servers to verify its identity to avoid fraudulent usage. Javascripts may also be used to provide information to the multimedia file format to indicate phone lines to call.

In an embodiment, a company can place several buttons on a web page and each button is associated with a specific phone number of a department specialized in certain products. For example, a call button is located right next to a picture such that a sales representative can immediately know what a user/customer wants to ask when receiving a call. Although, this display may be efficient and useful for customer experience, it may take up space on a web page. Alternatively, it is possible to have only a call button with a few options for selection on the side to accommodate many different products on a web page. Thus, this can save space on a web page especially when the display space is limited such as on a mobile device. Yet, another variation is to have a text field next to the call button to allow a customer to enter relevant information on the web page that he or she likes to send when making the call.

It is also possible to support multiple calls with web integrated voice and data at the same time as long as a company has enough support staff and infrastructure. Customers visiting at the same or different websites may decide to place calls at the same time, and the voice and data can be routed to appropriate receivers based on user's identification and other relevant information. A portal web page which will be described later can display all incoming callers' information at one place and at the same time.

### Mechanism Behind the Call Button for Web Integrated Voice and Data

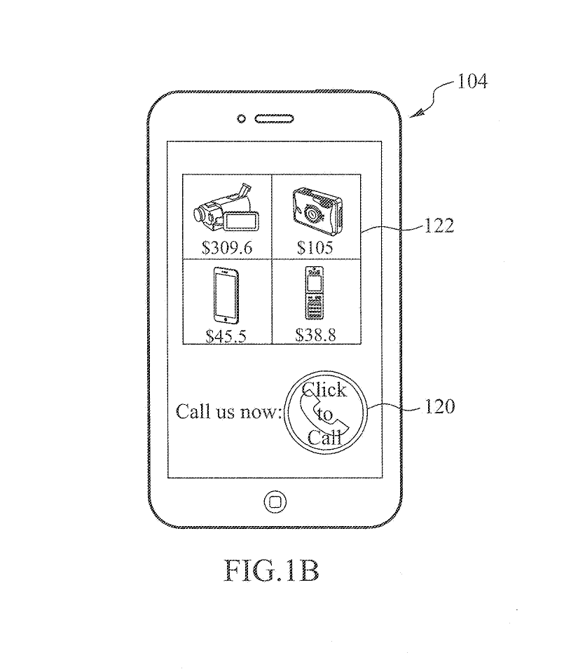

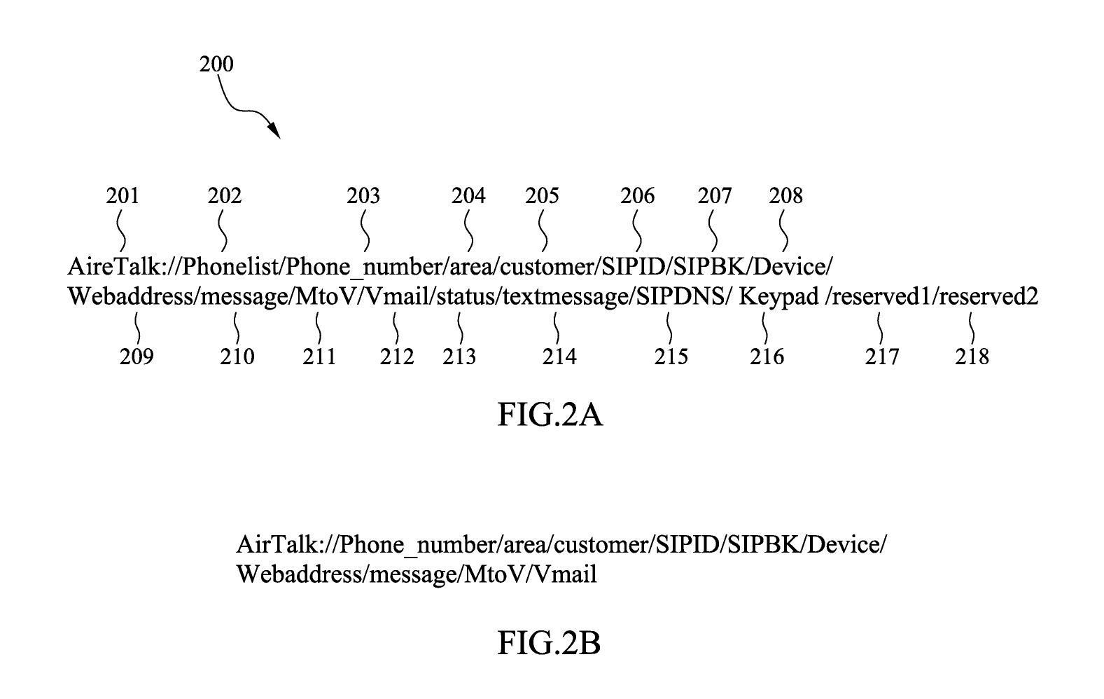

As mentioned earlier, there are several types of data that can be stored, encrypted and transmitted to receiver at the same time when a call is placed. These data are stored in a form or format of Uniform Resource Locator (URL) on a web page retrieved from a company's web servers and updated by the software on user's browser. A web page is a document or information resource displayed by a web browser on a device and is usually in HTML or XHTML format. In an embodiment, a call button displayed as an icon on the web page is linked directly to this URL which is encrypted as a line (or an element or object) in the web page content and is decrypted and parsed before sending to a receiver. An example of such data stored in URL format 200 is shown in FIG. 2.

When a website visitor opens a web page, the HTTP web server will first check the end device's browser type. If it is coming from a PC, the web server displays Adobe Flash as a call button on the web page. If it is coming from a mobile device, such as Android phone, iPhone, iPad devices, the web server displays call button image with underlining URL scheme. The reason is that mobile browsers do not support Adobe Flash so the mobile or PAD devices need to have software (mobile application) plug-in installed on the devices. The example here is a predefined URL storage format 200. In an embodiment, when a mobile caller clicks the call button on the web page, the underling mobile application built upon the techniques described in the embodiments of the invention will check the URL it clicked to see if it is the predefined URL scheme. If the URL links satisfy the predefined URL storage format 200, it launches a call from the mobile application to perform certain functions such as call and/or data exchange. After the action is completed, such as call completion, the underling mobile application needs to go back to the original web page where the call was made. Since the predefined URL storage format 200 is different from the regular URL, it needs to include the original web page address.

FIG. 2A illustrates an information storage format 200 for mobile/tablet/PAD device, according to an embodiment. The first field 201 is the scheme name of URL, as an example of “AireTalk” which tells a web browser to perform certain actions such as initiating a phone call or data exchange when software application identifies that it is the target predefined scheme name. Normally, a call button is an icon such as a phone image to allow user to know its self-explained purpose. In another embodiment, the scheme name can be “Airtalk_start” or “Airtalk_end” to tell software application that the icon may change display after a caller clicks the call button to indicate a next action. For example, a call button associated with an URL storage format having scheme name “Airtalk_start” will change its display from a phone image to “CANCEL” when it is connecting the call so the caller knows he or she has the option to cancel before the call is connected. When the call is connected, the icon display will change to “END”. At this point, the icon which displays “END” will be dynamically associated with a different URL storage format having scheme name “Airtalk_end” such that the software application can perform designated tasks in this new URL storage format (i.e. scheme name “Airtalk_end”) when user clicks this “END” display icon to end the call.

The second field “Phonelist” 202 is a phone list which indicates if there is a list of phone numbers and whether the software will look up alternative phone numbers to dial. It can also indicate the priority of phone numbers to call. The phone list may be stored in a server or other storage that can be looked up.

The third field “Phone_number” 203 is the default phone number to call. In case of the unavailability of this phone number, an alternative phone number will be used in the phone list from the second field, “Phonelist” 202. The phone number can be expressed in E164international number format.

The fourth field is “area” 204 which indicates caller's geographical location. The fifth field “customer” 205 is an identification that allows servers or systems to recognize and verify a user. This may be an account number, a user name, or other information suitable for verification purpose. It is also used to associate with user's information (e.g. personal information, profile pictures, videos, etc.) stored on servers and available to be retrieved to display on caller's devices when a call is initiated.

The sixth field “SIPID” 206 indicates a SIP/XMPP trunk or route ID. This ID is used to determine the routes a caller's voice and data will be used based on the caller's subscription. Different routes may have different reliability and cost depending on the subscriptions. The distance to SIP trunk proxy may be calculated and the route ID with shortest distance may be used for better quality to avoid jitter delay to SIP trunk proxy. This ID is updated on a regular basis to reflect caller's subscription. The seventh field “SIPBK” 207 indicates SIP/XMPP trunk's backup ID route when the first route fails or is congested where it can be detected by the plug-in software. The eighth field “Device” 208 indicates which kind of end device to be called such as POTS phone, a device enabled by techniques described in the embodiments of the invention, gtalk or Skype, etc.

The ninth field “Webaddress” 209 indicates the address of current website that user placed the call. One use of this field is to allow the web browser to return to the original website that user was viewing since the website may not be the same as what it started when the call finishes. Typically, the web servers will generate new web pages to display on user's web browser upon any status changes during the call. For example, the browser may display a successful phone connection or the browser may end with a confirmation page after the user order certain products over the phone. Another use of this field is to provide the receiver (i.e. called entity) knowledge of the specific web page that user is viewing regarding certain services or products the user is likely to inquire.

The tenth field “Message” 210 indicates data to be transmitted as well as types of data when a call is placed. As mentioned earlier, there are a few types of data available for transmission including web page location, browser cookies, user's web interaction information and user entered information. It can also be configured to allow users to select which type of information to be transmitted by possibly having a few enable/disable options next to the call button. This field may further include specific information associated with a call button such as names of icons or pictures of product items on the web page that are next to the call button. The purpose is to provide receiver as much knowledge as possible that a user is not able to or will take time to convey. The retrieval and transmission of these data will be described more in detail later.

The eleventh field “MtoV” 211 indicates the data in the message field will be converted into voice. For example, when the receiver's device is a traditional phone which does not have capability to receive data, the text message can be converted into voice and inserted as part of the voice call. This encoded voice will be routed through SIP server using VoIP protocol.

The twelfth field “Vmail” 212 indicates whether the data and/or voice information will be recorded as a voice mail. This may be used when the receiving end is not available. Alternatively, a call button may be changed to or replaced by a microphone button that allows a user to speak and send out voice messages.

The thirteen field “Status” 213 indicates whether the receiver is online or not, or has a device enabled by techniques described in the embodiments of the invention. This field can be updated in real time based on receiver's status and reflects on the call button as different colors. For example, the receiver or host of the website that includes the call buttons can set up time-of-day enablement which make the call buttons active for certain period of time during a day to avoid missing calls.

The fourteenth field “textmessage” 214 indicates whether to forward the entered text message to receiver at the phone number 203. The fifteenth field “SIPDNS” 215 indicates whether it needs to go to a SIP DNS (Domain Name System) server to download SIPID and SIPBK ID based on the geolocation of caller. This field is for mobile/tablet/PAD device. The sixteenth field “Keypad” 216 indicates whether the web browser will display a keypad after the call button is clicked. The keypad may be a small pop-up window with numeric number keys next to the call button and is useful when a product web page requests more information from users such as selecting more options. This field is for mobile/tablet/PAD device. The last two fields 217 and 218 are reserved for future use although more fields may be added.

Note that the URL content illustrated above is not exhaustive. The number of fields and content of each field may vary depending on applications and devices involved. For example, it may be decided that the field “Phonelist” 202 is not required and the call button is associated with a single phone number. Yet in another example, field “textmessage’ 214 may not be included if the application does not support text messaging capability. Further, a field “conference” may be included to enable a conference call feature which will be described in more detail later.

FIG. 2B is similar to the URL storage format of FIG. 2A but is for PC/MAC device, according to an embodiment. FIG. 2B does not have the fields of “status”, “textmessage”, “SIPDNS” and “Keypad” as an example.

In general, the content of this URL contains the parameters and data to be used to determine whom to call, what data will be sent and how to send. The URL is created by a service provider or a company who owns the website that displays the call button by using the techniques described in the embodiments of the invention and can be updated dynamically. In addition, various tools may be provided to allow a service provider to create an encrypted URL easily to place on their sales websites. All above information is also encrypted to ensure security and privacy.

### Portal Web Page

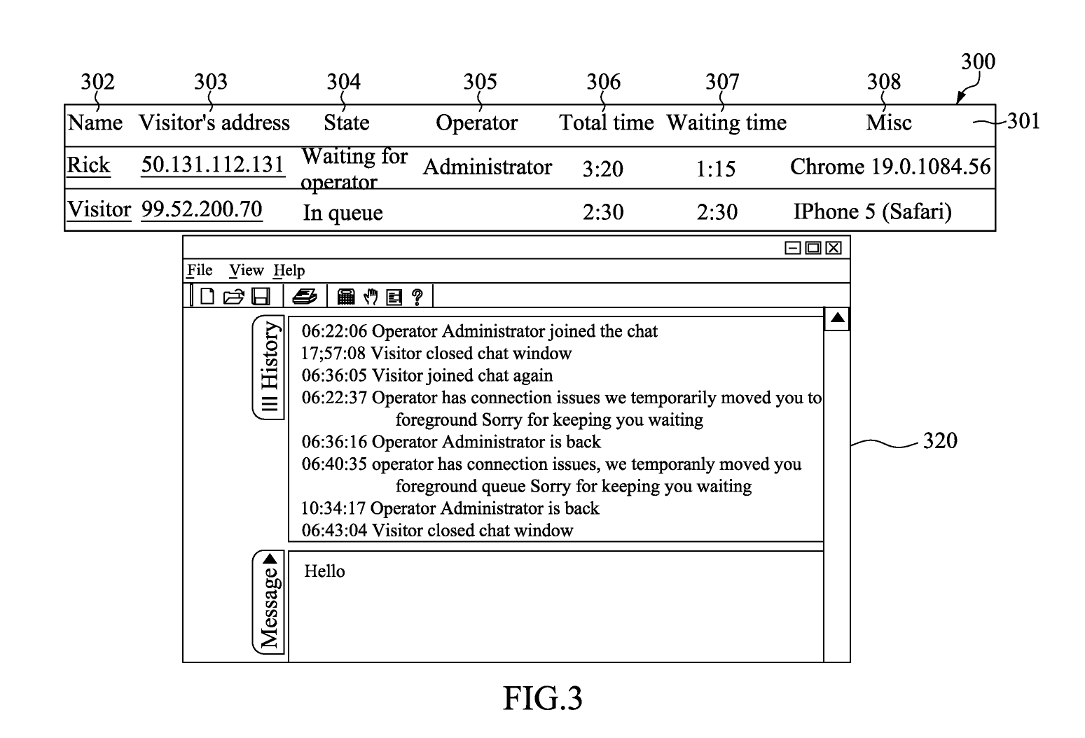

FIG. 3 is a block diagram illustrating information displayed on a portal web page, according to an embodiment. At the receiving end such as end user 108 in FIG. 1, a customer service portal page connected to various kinds of servers located in the cloud infrastructure is provided and can in real time display received information. By logging into the password protected portal page, a receiver has a complete view of a list of callers including both current awaiting callers and past callers. Under each caller, there is corresponding information listed as a table shown in FIG. 3. In the table 300, the first row 301 shows the current active caller's information including name, address, connection state, operator, total accumulated time, waiting time and other miscellaneous information such as caller's device or software capabilities. There are also a few icons (not shown) displaying caller's device and voice status.

In table 300, “Name” field 302 is obtained from transmitted customer's information. By clicking on the caller's name, the connection is established and information caller uploaded to servers are retrieved accordingly. “Visitor's address” 303 indicates caller's IP address which may also be displayed as name of a website that caller is viewing. “State” field 304 indicates the connection state whether the call has been placed and waiting to be answered or it is currently in progress (voice communication or chat). “Operator” field 305 indicates who at the receiving end is answering the call. “Total time” field 306 indicates the total time since the call is placed and connected. This directly translates into customer's experience of how long a customer has spent on this particular call. “Waiting time” field 307 indicates how long the call was waiting before answered. It provides an idea about the customer service quality and possibly the available resources such as staffing. “Misc” field 308 is miscellaneous information that might be useful to know customer's equipments and software capability. One example shown is the type of caller's device and/or browser and other related information.

As shown in FIG. 3, the table 300 displays a list of waiting callers (or users). The first two callers highlighted in bold have all information ready including both voice and data information. The first caller, Rick, has IP address 50.131.112.131 and is waiting for operator to answer his call. The operator designated is an administrator of the portal web page. The total time since the caller, Rick, started placing the call and providing information is 3 minutes 20 seconds. His waiting time after all information have been uploaded is 1 minutes 15 seconds. The table also shows that Rick calls from his computer with Chrome web browser of version 19.0.1084.56.

The second caller's name is shown as Visitor because he or she has not entered corresponding information and called from his or her mobile device, an iPhone5 with Safari browser. The visitor's IP address is 99.52.200.70 and the call has just entered the queue with the same total time and waiting time of 2 minutes 30 seconds.

Although this customer service portal page displays only a few fields, they are other transmitted information including user's entered information, cookies and other statistic information are not shown in this table but are available for display. For example, they may be displayed in a separate window or another web page with access link on the portal page. In addition, chat is available as shown in 320 besides the call. The chat is a separate pop-up window from receiver's portal web page.

The web portal page provides an overall snapshot of all callers' information. It is easy to manage and provide good quality of service. All displayed information can be compiled into useful statistics for analysis later.

### Conference Call Service

There are times when several parties in different geographical locations like to join a conference call for projects or product purchase. In an embodiment, a conference call web portal allows a coordinating party to login, setup and enable a conference call service. Then the coordinating party can send an email or other types of message that includes a web link to all participating parties. The attached web link in the email points to a conference call web page that includes a call button which can activate the conference call when a participant clicks the button to join. The mechanisms and functions of the call button are the same as what is described earlier. An information storage format in URL similar to the URL format 200 in FIG. 2 with various information is associated with this call button. In particular, the field “phone_number” 203 in FIG. 2A is the conference dial-in number that allow all participates to join the call. As a result, voice and texts can be exchanged among participants through a phone switch system and the conference call web page's Instance Message (IM) window respectively.

In another embodiment, the coordinating party may setup a conference start time, end time and participants through the conference call web portal and enable SIP server(s) to initiate a conference call to all participants at the start time. The SIP server(s) may retry the call until the scheduled end time if no participants are available. In an alternative embodiment, a conference URL storage format similar to the one in FIG. 2A may be created on the conference call web portal. This conference URL storage format includes an extra field “conference” in addition to other fields including “phone_list” 202 and “phone_number” 203. When the coordinating party clicks a call button associated with this conference URL storage format, a software application built upon the techniques described in the embodiments of the invention will call each participant on the “phone_list” to establish a conference call.

As described earlier, the URL storage format of FIG. 2 can be utilized for conference call purpose, therefore all participants can send user data to the coordinating party while exchanging voice and texts among each other.

### End to End Operation/Flow Description

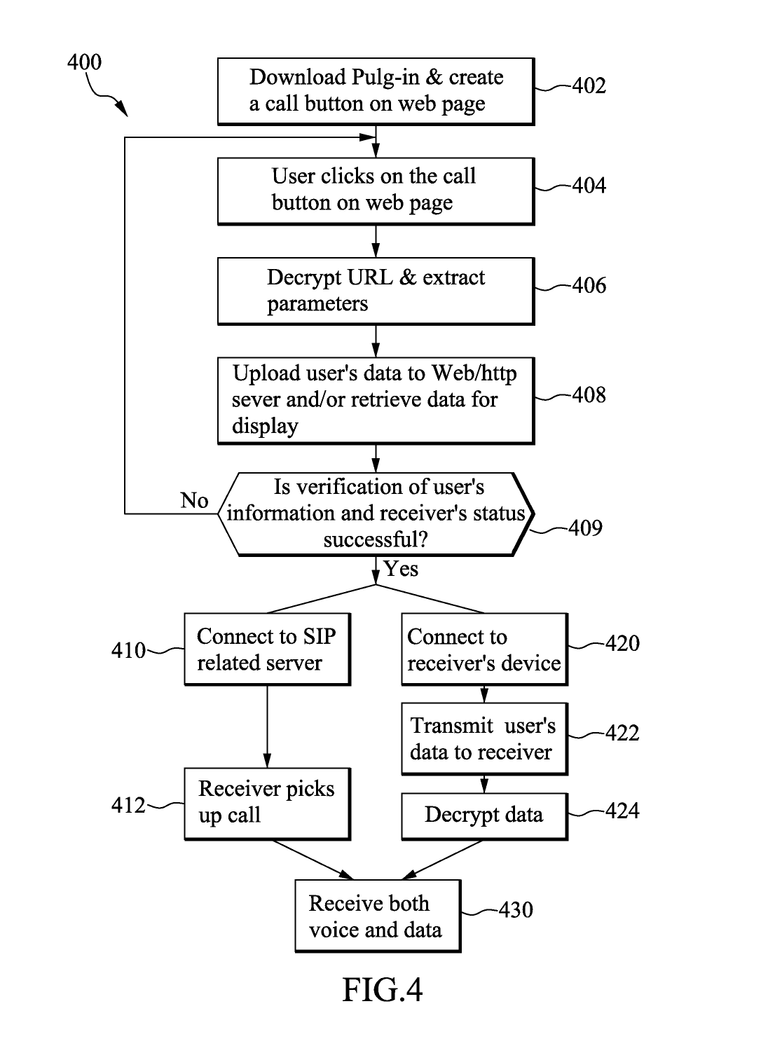

FIG. 4 is a flowchart illustrating steps for performing an end to end operation of the web integrated voice and data service, according to an embodiment. At step 402, a call button can be created by downloading a plug-in built upon the techniques described in the embodiments of the invention onto a particular web page by a web designer or a service provider. At step 404, a user can click the call button displayed on the particular web page he or she is viewing. At step 406, an element of a web page in URL format associated with the particular call button is decrypted to extract embedded caller's and receiver's information and other parameters.

At step 408, certain user's data (e.g. name, web address and phone number) is uploaded to one or more Web/HTTP servers for validation before transmitting all data to receiver. Some user's information (e.g. user's profile) may be retrieved from the corresponding servers for displaying on user's devices.

At step 409, the caller's identification is verified and receiver's availability and phone number are also verified. If either one of the verification status fails, the process returns to the original web page (i.e. step 404). If both validation statuses are successful, the servers may look up receiver's address (for data transfer) from their database based on the phone number provided and proceed to later steps 410 and 420. Alternatively, the servers that store user's data may communicate with the corresponding SIP related servers to obtain receiver's address. Other models of validation and information inquiry may also be implemented.

At step 410, a VoIP connection is routed through customer subscribed line via various types of servers including SIP related servers. At the same time at step 420 all users' data is uploaded to the corresponding Web/HTTP servers when they are connected to receiver's device. All users' data remains encrypted during upload or download to ensure security and privacy. In another embodiment, all user's data may be uploaded to Web/HTTP servers first and then verify user's identification.

At step 422, when the call is connected, user's data on the corresponding Web/HTTP servers are transferred to receiver based on receiver's address in parallel with the voice as two separate paths—VoIP path as in steps 410-412 and data path as in steps 420-422. When a receiver receives the data at step 424, it is decrypted to display on a portal web page of receiver's device or turned into voice if the receiver has only traditional phone as in step 430. When the call is finished, the software plug-in will direct user's device to return to the original web page the user was viewing before placing the call.

When the receiver side does not have the capability to receive data, a sender can upload text messages to servers which translate the text into voice and send to receiver when the call is placed. As mentioned earlier, chat is also available through a PHP server which connects both sender and receiver to exchange texts.

### Communication Protocols

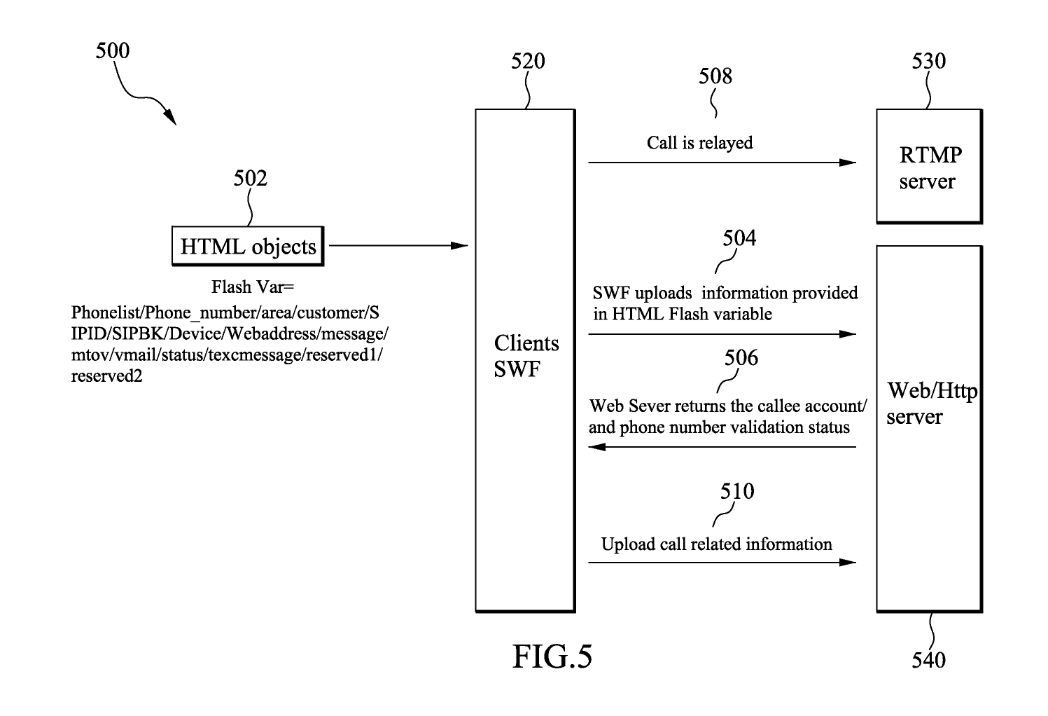

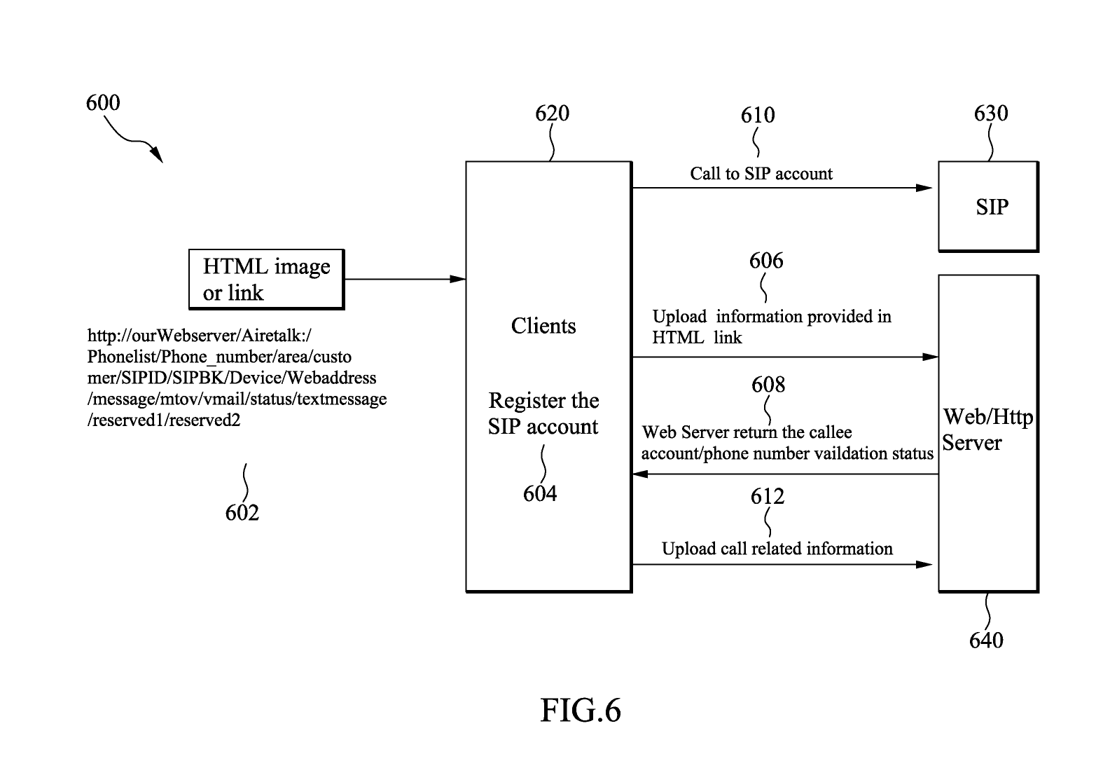

FIGS. 5 and 6 are block diagrams that illustrate the detailed communication protocols of PC and mobile client architectures respectively at sender side in the stages of connecting to SIP related servers and Web/HTTP server, according to embodiments.

In FIG. 5, the PC client architecture 500, a call button represented by client's multimedia file (swf) is associated with information stored in URL format 502 (aka. flash variable) which is a HTML object in this architecture. At step 504, when the call button is clicked, a web browser 520 incorporating a software plug-in built upon the techniques described in the embodiments of the invention together with the multimedia file decrypt the URL 502 and uploads all information in the flash variable (e.g. name, phone number and client's IP address) to Web/HTTP server 540 for validation. At step 506, the Web/HTTP server 540 looks up its database and returns the target receiver's account information and phone number validation status. At step 508, once the uploaded information is verified and the receiver is available, a call is relayed to an RTMP-SIP server 530 and followed by uploading call related data such as call start, end time, duration and status to Web/HTTP server 540 at step 510.

FIG. 6 shows the mobile/tablet/PAD client architecture 600. The call button, an html image, which is associated with information stored in URL format 602 (i.e. an html link), has a registered SIP account at step 604. At step 606, when the button is clicked, a software plug-in built upon the techniques described in the embodiments of the invention on client's device 620 decrypts the URL 602 and uploads all information in the URL 602 (e.g. name, phone number and client's IP address) to Web/HTTP server 640 for validation. At step 608, the Web/HTTP server 640 returns the receiver's account and phone number validation status. Once the uploaded information is verified and the receiver is available, a VoIP call is relayed to a SIP server 630 with the registered SIP account at step 610 and followed by uploading call related data such as call start, end time, duration and status to Web/HTTP server 640 at step 612.

It is noted that the above-described embodiments may comprise software. In such an embodiment, program instructions and/or a database (both of which may be referred to as “instructions”) that represent the described methods and/or apparatus may be stored on a computer readable storage medium. The term, “storage medium” as used herein refers to a non-transitory medium that stores instructions and/or data that cause a machine to operation in a specific fashion. For example, a computer readable storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g., synchronous dynamic RAM (SDRAM), doubledata rate (DDR, DDR2, DDR3, etc.) SDRAM, low-power DDR (LPDDR2, etc.) SDRAM, Rambus DRAM (RDRAM), static RAM (SRAM)), ROM, or non-volatile memory (e.g. Flash memory). Such media may be accessible locally to the processor or via a peripheral interface such as the PCIE interface, USB interface, etc. Storage media may include micro-electro-mechanical systems (MEMS), as well as storage media accessible via a communication medium such as a network and/or a wireless link.

In a nutshell, embodiments of the invention enable a better customer service experience by saving time and increasing accuracy and efficiency of communication. Customer service personnel can use various kinds of devices including desktop, laptop, mobile phones, tablets or even just traditional phones to provide services to customers. All the following drawbacks of traditional customer service calls can be pretty much eliminated—miscommunications, repeated questions, long menu selection time, customer's explanation of purpose and need, dialing wrong numbers and personal information leakage, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. An apparatus for web telephone communication, comprising:
a web page displayed on a web browser generated by one or more computing devices;
an icon displayed on said web page, wherein said icon is configured to enable a calling entity to initiate a phone call; and,
an element of said web page for storing information including at least one phone number, account identification and web address of said web page,
wherein said element of said web page is associated with said displayed icon and is encoded in Uniform Resource Locator (URL) format,
wherein said element of said web page is decoded, by said one or more computing devices, to obtain said at least one phone number to initiate said phone call when said calling entity clicks on said displayed icon.

2. The apparatus of claim 1, wherein said element of said web page is decoded to obtain said account identification for verification to establish said phone call.

3. The apparatus of claim 1, wherein said web address of said web page allows said web browser to return to said web page when said phone call is completed.

4. The apparatus of claim 1, wherein said element of said web page further comprises information displayed on said web page, wherein said displayed information on said web page is transmitted to a called entity concurrently with said phone call.

5. The apparatus of claim 1, wherein said at least one phone number is a phone list with a plurality of individual phone numbers associated with a plurality of respective conference call entities and a conference call is established when said calling entity clicks said icon to reach said plurality of conference call entities via said plurality of individual phone numbers.

6. A non-transitory computer-readable medium storing instructions which, when executed by one or more processors, cause performance of a method for web telephone-communication comprising the step of:
diaplaying a web page on a web browser;
displaying an icon on said web page;
initiating a phone call when a calling entity clicks said icon; and,
decoding an element of said web page to retrieve information including at least one phone number, account identification and web address of said web page,
wherein said element of said web page is associated with said displayed icon and is encoded in Uniform Resource Locator (URL) format,
wherein said at least one phone number is used to initiate said phone call.

7. The non-transitory computer-readable medium of claim 6, further comprising verifying said account identification of said decoded element to establish said phone call.

8. The non-transitory computer-readable medium of claim 6, further comprising returning to said web page via said web address when said phone call is completed.

9. The non-transitory computer-readable medium of claim 6, wherein said element of said web page further comprises information displayed on said web page, wherein said displayed information on said web page is transmitted to a called entity concurrently with said phone call.

10. The non-transitory computer-readable medium of claim 6, wherein said at least one phone number is a phone list with a plurality of individual phone numbers associated with a plurality of respective conference call entities and a conference call is established when said calling entity clicks said icon to reach said plurality of conference call entities via said plurality of individual phone numbers.

11. A method, comprising:
receiving a request to initiate a phone call to a called entity;
retrieving an element of a web page in response to said received request;
decoding said element to obtain an identification information associated with a calling entity and at least one phone number for initiating said phone call;
establishing a voice communication and a data communication with said called entity identified by said at least one phone number; and,
transmitting data associated with said identification information to said called entity,
wherein the method is performed by one or more computing devices.

12. The method of claim 11, wherein said element of said web page is in Uniform Resource Locator (URL) format.

13. The method of claim 11, wherein said element is encrypted on said web page.

14. The method of claim 11, wherein said element further comprising device information and availability status of said called entity.

15. The method of claim 11, wherein said transmitted data includes information that a calling entity intended to provide to said called entity or information associated with at least one item displayed on said web page.

16. The method of claim 11, wherein said called entity receives said voice and said data on a device.

17. The method of claim 11, further comprising displaying said web page on a device of said calling entity upon the completion of both voice and data communication.

18. The method of claim 11, wherein said element further comprises a phone list of two or more phone numbers, wherein said phone call is initiated based on a first phone number in said phone list.

19. The method of claim 18, further comprising initiating a phone call based on a next phone number in said phone list determining that said first phone number is not available.

20. The method of claim 11, wherein said transmitted data is converted into voice message if the device of said called entity is a voice only device.

21. A non-transitory computer-readable medium storing instructions which, when executed by one or more processors, cause performance of a method comprising the step of:
receiving a request to initiate a phone call to a called entity;
retrieving an element of a web page in response to said received request;
decoding said element to obtain an identification information associated with a calling entity and at least one phone number for initiating said phone call;
establishing a voice communication and a data communication with said called entity identified by said at least one phone number; and,
transmitting data associated with said identification information to said called entity.

22. The non-transitory computer-readable medium of claim 21, wherein said element of said web page is in Uniform Resource Locator (URL) format.
